(19) United States
(12) Patent Application Publication
(10) Pub. No.: US 2026/0069482 A1
(43) Pub. Date: Mar. 12, 2026

(54) Compresso-Inductive Body Cavity Evacuation

(71) Applicant: Scott Waguespack, Pensacola, FL (US)

(72) Inventor: Scott Waguespack, Pensacola, FL (US)

(21) Appl. No.: 19/319,102

(22) Filed: Sep. 4, 2025

Related U.S. Application Data
(60) Provisional application No. 63/691,931, filed on Sep. 6, 2024.

(51) Int. Cl. A61H 1/00; A61H 9/00; A61H 11/00

(52) U.S. Cl. CPC A61H 1/006; A61H 9/0078; A61H 11/00; A61H 2011/005; A61H 2201/1253; A61H 2201/1607; A61H 2201/169; A61H 2201/5071; A61H 2205/02

(57) ABSTRACT

Apparatus and related methods relate to inducing body cavity evacuation. In an illustrative embodiment, a compressive headgear may be configured to selectively apply compression to predetermined points on a patient's head. The headgear may, for example, include a contraction induction control unit. The control unit may, for example, be operable to control the compression level applied by the headgear. The predetermined points may, for example, include a first parietal surface. The points may, for example, include a second parietal surface opposing the first. The points may, for example, include an occipital surface. Various embodiments may advantageously induce muscular contraction around a target body cavity, facilitating evacuation.

### CROSS-REFERENCE TO RELATED APPLICATIONS

This application claims the benefit of U.S. Provisional Ser. No. 63/691,931, filed Sep, 6, 2024 by Scott Waguespack and titled “Automatic Selective Compression Induction of Endogenous Oxytocin.”

The entire contents of each of the foregoing applications and their priority applications, if any, are incorporated herein by reference.

Unless expressly stated, changes in terminology from priority application(s) to this application are made without prejudice or disclaimer of subject matter. Changes from the priority application(s) (e.g., provisional applications(s)) are intended to be broadening and/or additive unless expressly stated otherwise. Replacement of alternative terms with a single representative term, for example, are inclusive unless otherwise defined. Various embodiments may also be found in previous disclosure(s) incorporated by reference. Embodiments of similar languages in this application are not modifications or disclaimer of the embodiments disclosed in previous incorporated disclosures unless otherwise stated.

### BACKGROUND

Oxytocin is a hormone that plays a role in various physiological processes, particularly in childbirth and maternal behaviors. Notably, in some examples, oxytocin may be recognized for its function in labor and delivery. Oxytocin, for example, may be produced by the hypothalamus and released by the pituitary gland into the bloodstream. For example, oxytocin may stimulate uterine contractions during labor and facilitate the ejection of milk during breastfeeding.

During labor, as an illustrative example, oxytocin may be used for initiating and maintaining the rhythmic contractions of the uterine muscles to progress labor. These contractions, for example, help to dilate the cervix (the “os”). Oxytocin may, for example, promote expulsion of a placenta after delivery. In some examples, oxytocin may include a positive effect on the smooth muscles in the gastrointestinal tract. The hormone may, for example, stimulate bowel movements by increasing a motility of the intestines.

### TECHNICAL FIELD

Various embodiments relate generally to systems and methods for controlling muscular contractions.

### SUMMARY

Apparatus and related methods relate to inducing body cavity evacuation. In an illustrative embodiment, a compressive headgear may be configured to selectively apply compression to predetermined points on a patient's head. The headgear may, for example, include a contraction induction control unit. The control unit may, for example, be operable to control the compression level applied by the headgear. The predetermined points may, for example, include a first parietal surface. The points may, for example, include a second parietal surface opposing the first. The points may, for example, include an occipital surface. Various embodiments may advantageously induce muscular contraction around a target body cavity, facilitating evacuation.

Apparatus and associated methods may, for example, relate to a device to automatically apply compression to a body part (e.g., a patient's head) based on a target level of endogenous oxytocin generated and/or effect generated (e.g., muscle contraction level, pressure). In an illustrative example, an endogenous compression headgear (ECH) may include a compression module. The compression module, for example, when the ECH is worn by the patient, may apply a pressure to predetermined pressure application area to induce natural oxytocin production. The compression module may be operably coupled to a controller. For example, the controller may control the compression module and pressure being applied to the patient based on one or more sensor readings (e.g., pressure sensor, blood pressure sensors). For example, the patient body may respond by generating oxytocin according to the pressure being applied to the predetermined application areas. Various embodiments may advantageously induce internal balancing pressure and/or contraction.

Various embodiments may achieve one or more advantages. For example, some embodiments may advantageously reduce the risk of prolonged labor or stalled delivery. Some embodiments, for example, may advantageously reduce administration of exogenous oxytocin. For example, some embodiments may advantageously prevent the overstimulation of uterine muscles. Some embodiments may, for example, advantageously reduce discomfort from bowel movement. For example, some embodiments may advantageously induce complete bowel movements.

The details of various embodiments are set forth in the accompanying drawings and the description below. Other features and advantages will be apparent from the description and drawings, and from the claims.

### BRIEF DESCRIPTION OF THE DRAWINGS

Various embodiments of the present embodiments are described with reference to the following FIGURES.

FIG. 1 depicts an exemplary endogenous muscle contraction induction system (EMCIS) employed in an illustrative use-case scenario.

FIG. 2A, FIG. 2B, FIG. 2C, and FIG. 2D depict exemplary application areas for the EMCIS.

FIG. 3 is a flowchart illustrating an exemplary EMCIS operation method.

FIG. 4 is a perspective view of a compressive headgear with associated components.

FIG. 5 depicts an example compressive headgear.

FIG. 6 is a perspective view illustrating lateral and vertical motion of the endogenous muscle contraction induction system.

FIG. 7A is a front view of a positioning headgear with a sinciput compression module.

FIG. 7B is a rear view of an occipital compression module connected to a pressure source.

FIG. 8 is a diagram showing a first configuration and a second configuration of a compressive headgear.

Like reference numerals refer to like parts throughout the various views unless otherwise specified. Embodiments and portions of embodiments illustrated and described herein are non-limiting and non-exhaustive.

### DETAILED DESCRIPTION

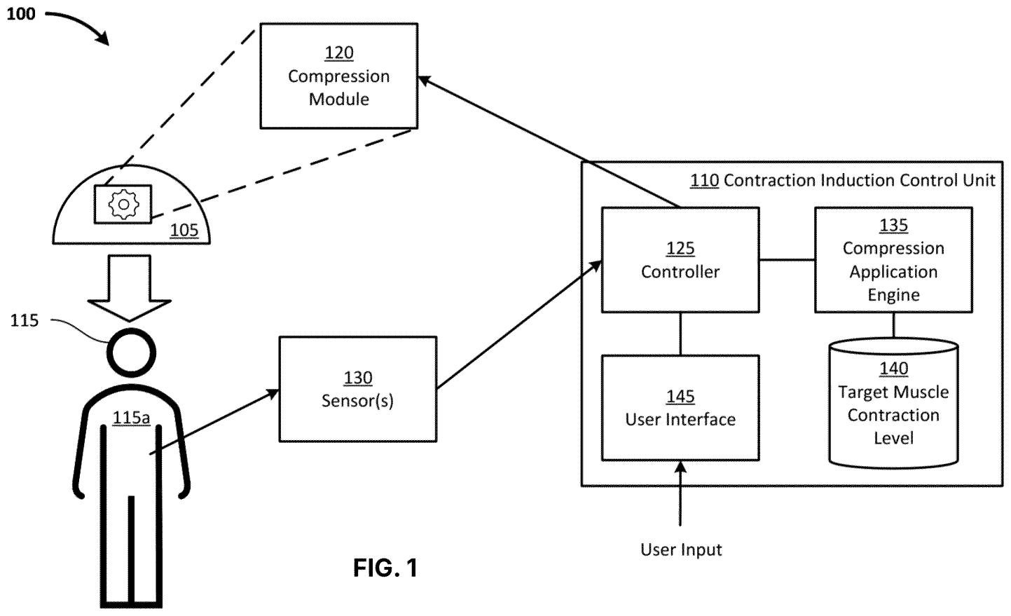

FIG. 1 depicts an exemplary endogenous muscle contraction induction system (EMCIS) employed in an illustrative use-case scenario. In the depicted example, an EMCIS 100 may include an endogenous compressive headgear (ECH 105) and a contraction induction control unit (CICU 110). For example, the ECH 105 may selectively apply compression to an upper head 115 of a patient 115a. The ECH 105 may selectively apply compression to, for example, one or more areas of the upper head 115(e.g., an upper bridge of the nose, an underside of the optical sockets). In some implementations, the compression from the ECH 105 may be indirectly applied to optic nerves of the upper head 115.

In some examples, the selectively applied compression may induce the patient to endogenously generate oxytocin. For example, the endogenously generated oxytocin may be produced in the gastrointestinal tract (e.g., in the colon). For example, the oxytocin may be generated in the reproductive system (e.g., uterus). For example, the oxytocin may be generated in the genitourinary system.

In the depicted example, the ECH 105 includes a compression module 120. For example, the compression module 120 may be configured to selectively apply a gentle squeezing to the upper head 115. The compression module 120 may, for example, include an inflator (e.g., inflatable compartments). The compression module 120 may include a tightening band(s). The compression module 120 may include shape memory materials.

The compression module 120 is operably coupled to a controller 125 of the CICU 110 in this example. For example, the controller 125 may control the compression module 120 based on a compression application engine (CAE 135). For example, the controller 125 may control a pressure being applied to the upper head 115 based on the CAE 135. For example, the CAE 135 may be a software stored in a memory and/or a storage module of the CICU 110. The storage module may, for example, include one or more storage modules (e.g., non-volatile memory).

As shown, the controller 125 is operably coupled to one or more sensors 130. For example, the controller 125 may monitor a pressure sensor detecting the pressure applied to the head by the compression module 120. The controller 125 may automatically adjust the compression based on compression applied to the head (e.g., maximum pressure). The controller 125 may, for example, monitor a pressure sensor detecting the pressure of contraction.

In some implementations, the controller 125 may selectively operate the compression module 120 to induce uterine contraction. The controller 125 may, for example, monitor muscle contraction. The controller 125 may selectively operate the compression module 120 to induce a target muscle contraction level 140. In some implementations, the target muscle contraction level 140 may be dynamically generated based on a contraction level model. For example, the contraction level model may generate the target muscle contraction level 140 based on time (e.g., a duration of a single use of the EMCIS 100, user feedback and input, a historical records of application of the EMCIS 100 to the patient 115a, sensor measurements from the CAE 135).

In this example, the CICU 110 includes a user interface 145. For example, the patient 115a and/or an operator of the EMCIS 100 may provide observation (e.g., patient's feedback, patient's current situation, an operating mode such as for labor or bowel movement or other muscle contraction inducement) using the user interface 145. In some implementations, the user interface 145 may include a graphical user interface of a mobile application remotely connected between a user's mobile device and the CICU 110.

In some embodiments, the endogenous oxytocin generation device may advantageously induce internal balancing pressure and/or contraction. By endogenous oxytocin generation, an entire body of the patient 115a may cooperate in generating a forward pressure to evacuate a target system (e.g., a uterus, a colon). For example, an internal balancing pressure may prevent backwards pressure by one-way application of external oxytocin. Backward pressure, in the context of labor and delivery, may refer to counterproductive forces that resist a forward progress of the baby through a birth canal. This may occur when there is an imbalance between the forces pushing the baby downward and those that inadvertently push back against this movement. In various cases, backward pressure may be exacerbated by improper timing or excessive administration of oxytocin. These unregulated contractions may cause the cervix to close prematurely or create a force that opposes the natural progression of labor. For example, reducing backwards pressure may reduce uterine injury and/or infant injury from oxytocin induction.

In some implementations, the EMCIS 100 may be self-operated. For example, the patient 115a may observe (e.g., from the user interface 145, using a separate measurement device) measure pressure of contraction in the body. Based on the measurement, for example, the patient 115a may operate the ECH 105 to generate endogenous pressure to overcome the pressure of contraction.

In some implementations, the CICU 110 may be configured to respond to real-time pressure for the patient 115a. As an illustrative example, the CAE 135 may be configured to regulate a pressure for a delivery (e.g., labor) process. In some examples, the pressure may be determined based on other monitoring devices in a labor and delivery room (e.g., blood pressure monitoring cuff on a patient's arm). In some examples, other pressure-detecting devices may be used. For example, the pressure may be measured in mmHg.

In this example, the EMCIS 100 may be configured to be autonomously operated. For example, the CAE 135 may instruct the controller 125 to generate control signals to control the compression module 120 based on measurements from the one or more sensors 130 (e.g., pressure sensor, contraction sensor(s)).

In some examples, the ECH 105 may be operated manually. For example, an operator may use the ECH 105 to assist contraction (e.g., for labor and delivery) for the patient 115a. In some implementations, the operator may operate the ECH 105 by direct visualization (e.g., look at patient). In some implementations, the operator may operate the ECH 105 based on verbal & non-verbal cues.

The CAE 135, for example, may include functions to determine a pressure value (e.g., the target muscle contraction level 140) to be delivered to the upper head 115 by the ECH 105. For example, the CAE 135 may determine the target muscle contraction level 140 in mmHg. For example, the target muscle contraction level 140 may be determined to, for example, deliver to the head in order to counter and/or overcome a “backward flow” or a backward pressure. In some implementations, the CAE 135 may be configured to monitor and mitigate the backward pressure. In some implementations, the target muscle contraction level 140 may be determined to, for example, downregulate or upregulate oxytocin.

In some embodiments, the EMCIS 100 may be configured to promote synchronized cervical dilation (e.g., a cervical os opening) in conjunction with forward contractions. By precisely coordinating the timing and intensity of applied pressure through the ECH 105, for example, the EMCIS 100 may encourage the cervix to dilate in harmony with natural uterine contractions. Various embodiments may advantageously reduce the risk of prolonged labor or stalled delivery. Accordingly, for example, the EMCIS 100 may advantageously reduce administration of exogenous oxytocin. In some examples, naturally oxytocin induced by the EMCIS 100 may advantageously prevent the overstimulation of uterine muscles.

In some examples, a user may use the EMCIS 100 to stimulate bowel movement. For example, a user may increase and/or decrease pressure applied by the ECH 105 based on self-feeling. For example, the user may adjust the pressure using the user interface 145. For example, the user interface 145 may include a bulb configured to manually control an applied pressure at the compression module 120. Various embodiments may advantageously reduce discomfort from bowel movement.

In some implementations, the compression module 120 may apply a range of pressure (e.g., 2-220 mmHg).

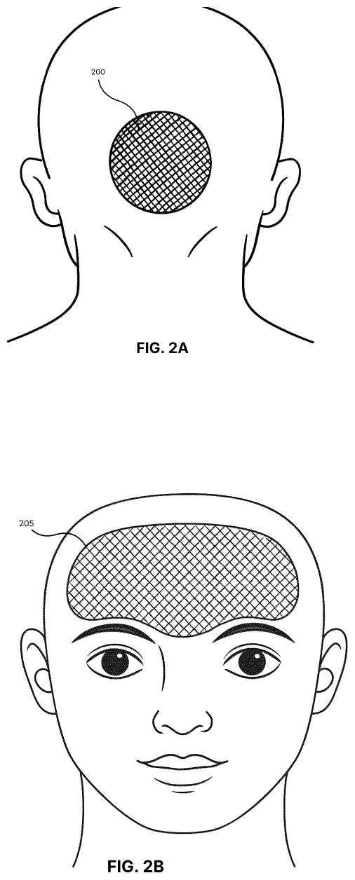

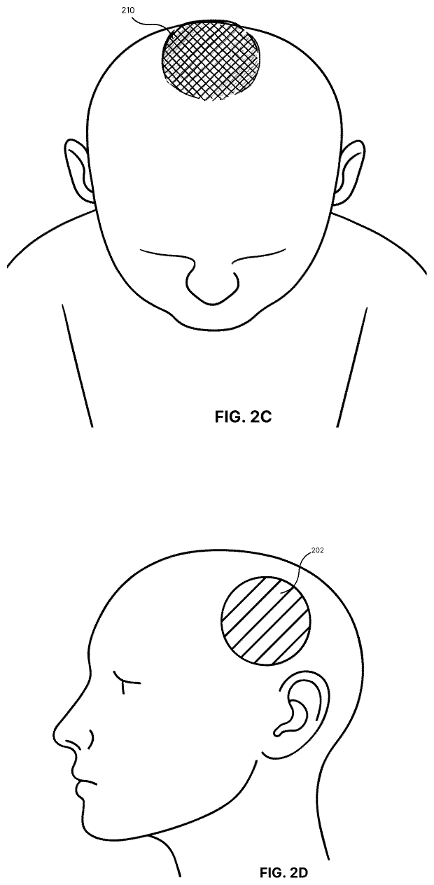

FIG. 2A, FIG. 2B, FIG. 2C, and FIG. 2D depict exemplary application areas for the EMCIS. As shown in FIG. 2A, a first application area 200 may be at a back of a head (e.g., occipital). As shown in FIG. 2B, a second application area 205 may be at a forehead (e.g., sincipital). As shown in FIG. 2C, a third application area 210 may be on a top of the head (e.g., calvarial). As shown in FIG. 2D, a fourth application area(s) 215 may be on (both) side(s) of the head (e.g., parietal).

In some implementations, a user may apply to the application areas 200, 205, 210, 215 using the EMCIS 100. In some implementations, the user may apply to the application areas 200, 205, 210, 215 using a hand device (e.g., the ECH 105, other hand devices, other non-sharp objects). For example, the hand device may align with one or more of the application areas 200, 205, 210, 215 to apply pressure at predetermined points.

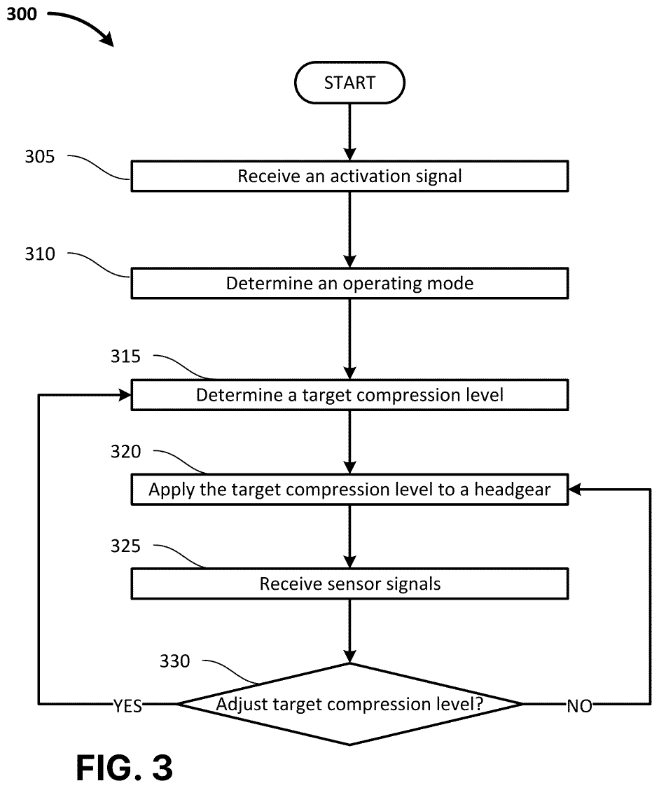

FIG. 3 is a flowchart illustrating an exemplary EMCIS operation method. For example, the controller 125 may perform a method 300 as shown in FIG. 3. In this example, the method 300 begins in step 305 when an activation signal is received. For example, the controller 125 may receive the activation signal from a user interface 145 (e.g., from the patient 115a).

In step 310, an operating mode is determined. For example, the controller 125 may select the appropriate operating mode based on input from the user or pre-programmed settings, such as a mode for inducing labor contractions or stimulating bowel movements. Next, a target compression level is determined in step 315. For example, the CAE 135 may calculate the appropriate compression level based on the selected operating mode, user feedback, and/or sensor data.

In step 320, the target compression level is applied to a headgear. For example, the controller 125 may control the compression module 120 to adjust the pressure applied by the ECH 105 to the upper head 115 of the patient 115a. After the target compression level is applied to a headgear, sensor signals are received in step 325. For example, the controller 125 may monitor real-time data from the one or more sensors 130, including pressure sensors and contraction sensors, to assess the effectiveness of the applied compression.

At a decision point 330, it is determined whether to adjust the target compression level. For example, the CAE 135 may evaluate the sensor signals to decide if the current compression level should be modified to better achieve the desired outcome (e.g., to downregulate or upregulate oxytocin). If an adjustment is determined, the step 315 is repeated. If no adjustment is needed, the step 320 is repeated.

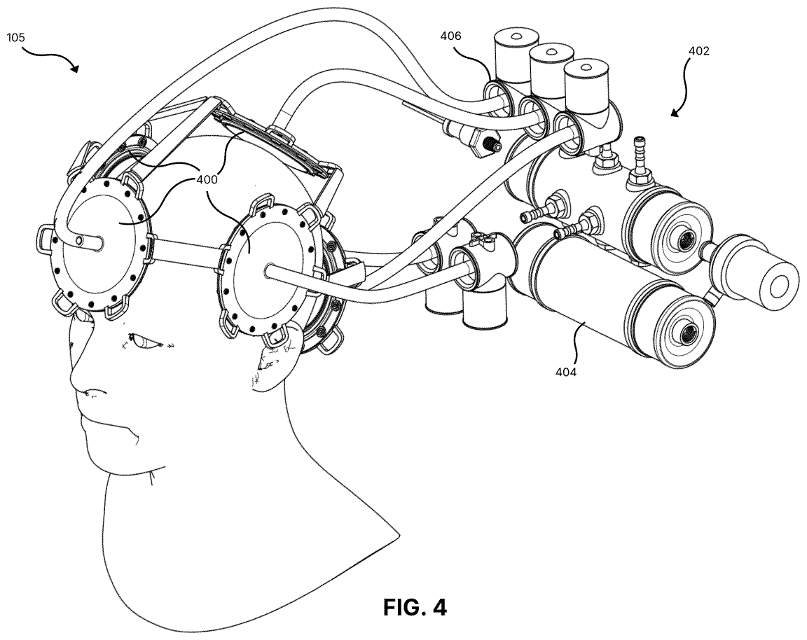

FIG. 4 shows a compressive headgear 105 configured to apply compression to a patient's head. The compressive headgear 105 includes compression modules 400. The compression modules 400 are fluidly connected to a compression controller 402. The compression controller 402 manages a level of compression of the compression modules 400. The compression controller 402 may, for example, form part or all of, or otherwise be operably coupled to, the contraction induction control unit 110.

The compression controller 402 includes manifolds 404. The manifolds 404 selectively distributes fluid to the compression modules 400 via valve modules 406. The valve modules 406 regulate the flow and pressure within the system, ensuring precise control of the compression applied by the compressive headgear 105.

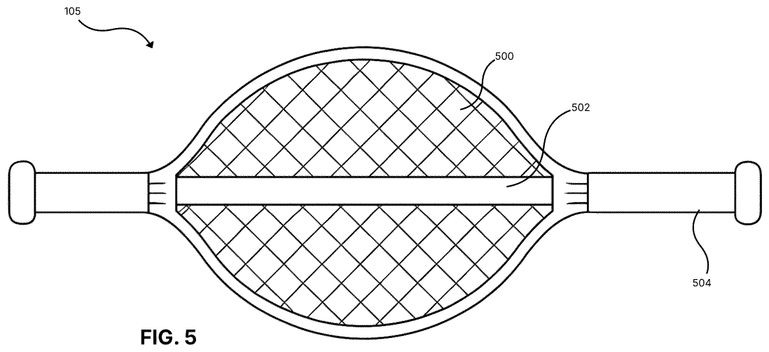

FIG. 5 shows a compressive headgear 105. The compressive headgear 105 includes a distributed pressure applicator 500. The distributed pressure applicator 500 may, for example, be configured to apply pressure over a broad area. In this example, the distributed pressure applicator 500 includes a localized pressure applicator 502. The localized pressure applicator 502 may, for example, be configured to focus pressure on specific point(s).

The compressive headgear 105 may, for example, include handles 504. The handles 504 may be attached to the compressive headgear 105. In some embodiments, the handles 504 may facilitate manual operation. The handles 504 may, for example, allow for easy adjustment of the pressure applied by the headgear.

In some embodiments, the handles of the compressive headgear 105 may include features to engage the head. In some examples, the handles may include a hook. The hook may, for example, be configured to hook under the chin of the patient 115a. This configuration may allow an operator to squeeze the handles together. In some examples, the handles may be squeezed with a single hand. This may vary the pressure applied by the compressive headgear 105. This configuration may advantageously provide ease of use. Precise control over the pressure application may be achieved, for example. This may be beneficial in various use-case scenarios. Some examples of use-case scenarios may include labor induction or bowel movement stimulation.

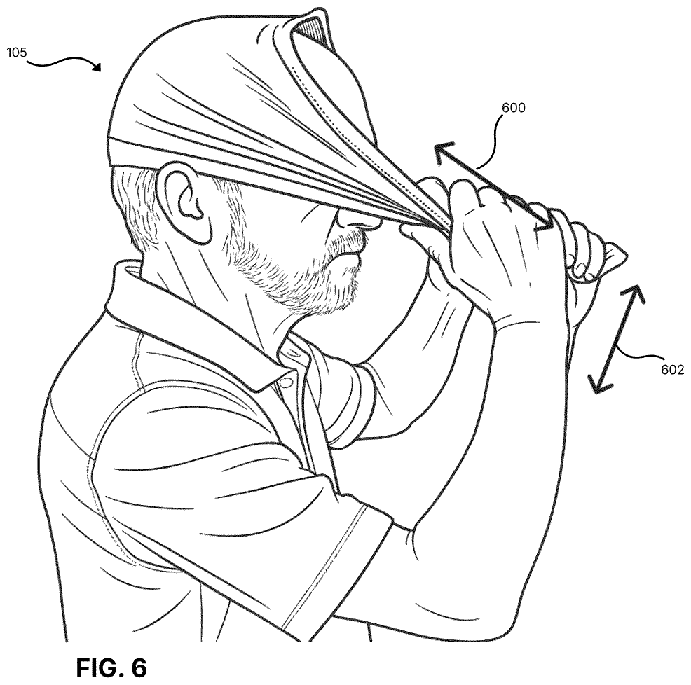

FIG. 6 shows a compressive headgear 105 being utilized by a user. The compressive headgear 105 is depicted as being positioned on the upper head of the user. This positioning illustrates its application in a practical scenario. The headgear 105 may, for example, be configured to apply compression to specific areas of the head. Such compression may potentially aid in the induction of endogenous muscle contractions.

The figure illustrates lateral motion 600. This lateral motion 600 may, for example, include motion of the handles 504 towards/away from each other. Such adjustment may allow for the modification of the level of pressure applied to target points. Adjusting the pressure level may advantageously enable sequential application of pressure to points shown in FIGS. 2A-2D.

Vertical motion 602 is depicted with an arrow indicating up and down movement. Moving the handles 504 up/down (vertically) may, for example, advantageously modify the level of pressure applied to target points. Modifying the pressure level may potentially allow for sequential application of pressure to points shown in FIGS. 2A-2D.

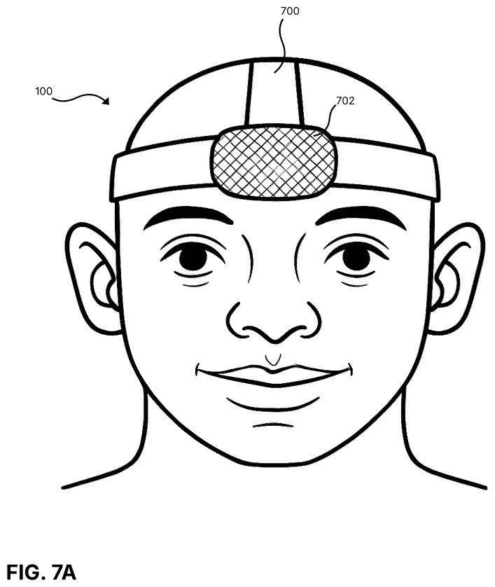

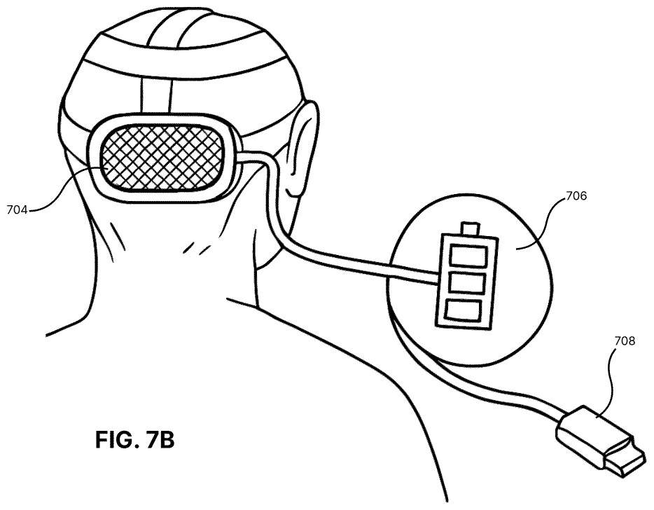

Turning to FIG. 7A, the figure illustrates an endogenous muscle contraction induction system 100. The system 100 includes a positioning headgear 700. The positioning headgear 700 is configured to be worn on the head of a user. In some embodiments, the positioning headgear 700 may provide stability. In some examples, the positioning headgear 700 may secure the placement of the system 100 on the user's head. The sinciput compression module 702 is integrated into the positioning headgear 700. The sinciput compression module 702 may apply pressure to the frontal region of the head. This pressure application may, for example, facilitate muscle contraction in targeted areas.

FIG. 7B shows additional components of the endogenous muscle contraction induction system 100. The occipital compression module 704 is depicted at the rear of the head. The occipital compression module 704 may apply pressure to the back of the head. This pressure application may, for example, complement the function of the sinciput compression module 702. A pressure source 706 is connected to the occipital compression module 704. The pressure source 706 may regulate the pressure applied by the compression modules. In some examples, the pressure source 706 may be adjustable. This adjustability may, for example, accommodate different user needs. The pressure source 706 is connected to a power supply 708. The power supply 708 may provide energy to operate the pressure source 706. This energy provision may, for example, ensure consistent performance of the system 100.

In some embodiments, the pressure source 706 may include a pump. The pump may, for example, pump fluid into selected compression modules. This fluid may, for example, include air. In some examples, the fluid may include water. The use of a pump may, for example, allow for precise control of the pressure applied by the compression modules.

In some embodiments, the pressure source 706 may include a manual pressure source. The manual pressure source may, for example, include a pump bulb. A pump bulb may, for example, allow a user to manually adjust the pressure applied by the compression modules. This manual adjustment may, for example, provide flexibility for the user to tailor the pressure to their specific needs or preferences.

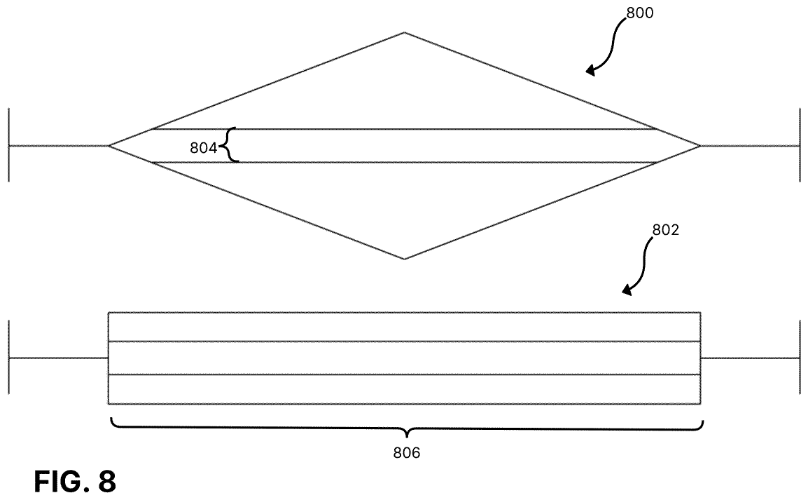

Turning to FIG. 8, the diagram illustrates example configurations of a compressive headgear 105 (e.g., as shown in FIG. 5). A first configuration 800 is depicted at the top of the figure. This configuration may, for example, include a structure that is more distributed.

A second configuration 802 is shown below the first configuration 800. This configuration may, for example, provide a more ‘streamlined’and/or focused pressure configuration.

Various embodiments may have varying width 804 and/or length 806. For example, length 806 may vary from 14 inches or less (e.g., for an infant) to 25 inches or more (e.g., for an adult).

A width 804 (e.g., of a localized pressure applicator 502) may vary from 2 inches or less (e.g., for an infant) to 4 inches or more (e.g., for an adult). Width may, for example, be varied according to a shape and/or desired pressure concentration.

Appendix A depicts images of use. Appendix B depicts example engineering drawings of an illustrative embodiment. Appendix C depicts example configurations.

Although various embodiments have been described with reference to the figures, other embodiments are possible. In some implementations, the EMCIS 100 may be used for defecation by applying pressure to specific points on the upper head 115 (e.g., around the head, at the application areas 200, 205, 210, 215, around an ear). The specific pressure points may be manipulated by hand. For example, the application may advantageously be non-invasive. As an illustrative example, if there is a need to induce a bowel movement earlier than usual (e.g., before a meeting), the user may apply the pressure using the EMCIS 100. Upon feeling the initial stimulus for a bowel movement, in some implementations, the EMCIS 100 may be used to halt the flow, alleviating a headache and/or discomfort associated with constipation. In some implementations, the EMCIS 100 may advantageously induce complete bowel movements (e.g., eliminating the need for toilet paper due to the thoroughness of the evacuation).

Although an exemplary system has been described with reference to the figures, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2,.) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. Elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAS, ASICs), or some combination thereof. In some embodiments, the module(s) may involve execution of preprogrammed instructions, software executed by a processor, or some combination thereof. For example, various modules may involve both hardware and software.

As an illustrative example, a system is designed to help evacuate body cavities. The system includes a compressive headgear that can apply pressure to the upper part of a patient's head. The system also includes a control unit that works with the headgear. The control unit has a controller that manages the pressure applied by the headgear. It also includes a compression application engine that determines a target level of muscle contraction. Additionally, there is at least one sensor connected to the controller that monitors the effects of the pressure applied by the headgear. The controller adjusts the pressure based on the monitored effects to achieve the target muscle contraction level.

In some examples, an apparatus includes a compressive headgear that can apply pressure to several specific points on a patient's head. These points include areas on the first and second parietal surfaces and the occipital surface. The apparatus also includes a control unit that manages the pressure applied by the headgear to induce muscle contraction around a target body cavity, facilitating its evacuation.

In some examples, the compressive headgear includes a textile region that allows pressure to be applied at different levels across the specific points.

In some examples, the compressive headgear includes a compression module that can apply a squeezing action to the upper head.

In some examples, the compression module includes an inflator.

In some examples, the compression module includes a tightening band.

In some examples, the compression module includes materials that can remember their shape.

In some examples, the control unit includes a controller that manages the pressure applied by the headgear. It also includes a compression application engine that determines a target muscle contraction level. Additionally, there are sensors connected to the controller that monitor the pressure applied by the headgear.

In some examples, the control unit includes a user interface that allows a user to provide input.

In some examples, the compression application engine can dynamically generate a target muscle contraction level based on a model.

In some examples, the sensors include a pressure sensor that detects the pressure applied to the head by the compression module.

In some examples, the control unit can operate autonomously based on sensor measurements.

In some examples, the controller can operate the headgear to induce uterine contraction.

In some examples, the controller can operate the headgear to induce bowel movement.

As an illustrative example, a method is used to induce muscle contraction around a target body cavity. The method involves providing a compressive headgear that can apply pressure to several specific points on a patient's head. The headgear includes a control unit that manages the pressure applied. The method involves applying pressure to the specific points on the head using the headgear. These points include areas on the first and second parietal surfaces and the occipital surface. The method involves managing the pressure applied by the headgear using the control unit to induce muscle contraction around the target body cavity, facilitating its evacuation.

In some examples, applying pressure involves applying a force to the control unit, which then transfers the force into a corresponding level of pressure.

In some examples, applying the force involves pulling handles.

In some examples, applying the force involves squeezing input modules.

In some examples, applying pressure involves using a control interface of the control unit to manage the activation of actuators in the headgear, resulting in a corresponding level of pressure.

In some examples, the target body cavity includes the bowels.

In some examples, the target body cavity includes the uterus.

As an illustrative example, a method for inducing endogenous muscle contraction may include receiving an activation signal. The method may involve determining an operating mode. The method may include determining a target compression level based on the operating mode. The method may involve applying the target compression level to a headgear. The method may include receiving sensor signals. The method may involve determining whether to adjust the target compression level based on the sensor signals.

In some examples, determining the target compression level may involve calculating the compression level based on user feedback and sensor data.

In some examples, applying the target compression level may involve controlling a compression module to adjust pressure applied by an endogenous compressive headgear.

In some examples, receiving sensor signals may involve monitoring real-time data from one or more sensors, including pressure sensors and contraction sensors.

In some examples, determining whether to adjust the target compression level may involve evaluating sensor signals to decide if the compression level should be modified to achieve a desired outcome.

As an illustrative example, a system for promoting synchronized cervical dilation may include an endogenous compressive headgear configured to apply pressure to an upper head of a patient. The system may include a contraction induction control unit operably coupled to the endogenous compressive headgear. The contraction induction control unit may include a controller configured to coordinate timing and intensity of applied pressure. The contraction induction control unit may include a compression application engine configured to determine a target muscle contraction level. The contraction induction control unit may include one or more sensors configured to monitor pressure applied by the endogenous compressive headgear.

In some examples, the contraction induction control unit may be configured to reduce administration of exogenous oxytocin.

In some examples, the contraction induction control unit may be configured to prevent overstimulation of uterine muscles.

In some examples, the contraction induction control unit may be configured to reduce the risk of prolonged labor or stalled delivery.

As an illustrative example, a method for stimulating bowel movement may include applying pressure to an upper head of a patient using an endogenous compressive headgear. The method may involve adjusting the pressure based on self-feeling. The method may include using a user interface to control the applied pressure.

In some examples, the user interface may include a bulb configured to manually control the applied pressure.

In some examples, the pressure may be applied to specific points on the upper head to induce bowel movement.

In some examples, the method may be configured to reduce discomfort from bowel movement.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A system for inducing body cavity evacuation, comprising:
a compressive headgear configured to selectively apply compression to an upper head of a patient;
a contraction induction control unit operably coupled to the compressive headgear, the contraction induction control unit comprising:
a controller configured to control the compression, applied by the compressive headgear;
a compression application engine configured to determine a target muscle contraction level; and
at least one sensor, operably coupled to the controller, configured to monitor an outcome of the compression, applied by the compressive headgear,
wherein the controller controls the compression, applied by the compressive headgear, based on the outcome of the compression, such that a target muscle contraction level is obtained.

2. An apparatus comprising:
a compressive headgear configured to selectively apply compression to a plurality of predetermined points on a head of a patient, wherein the plurality of predetermined points comprise points located:
on a first parietal surface,
on a second parietal surface opposing the first parietal surface, and
on an occipital surface; and
a contraction induction control unit coupled to the compressive headgear, the contraction induction control unit operable to control a level of the compression, applied by the compressive headgear, such that muscular contraction is induced around a target body cavity, inducing evacuation of the target body cavity.

3. The apparatus of claim 2, wherein the compressive headgear comprises a textile region configured such that applying the compression comprises applying at least one level of pressure at a time across the plurality of predetermined points.

4. The apparatus of claim 2, wherein the compressive headgear comprises a compression module configured to selectively apply a squeezing to an upper head.

5. The apparatus of claim 4, wherein the compression module comprises an inflator.

6. The apparatus of claim 4, wherein the compression module comprises a tightening band.

7. The apparatus of claim 4, wherein the compression module comprises shape memory materials.

8. The apparatus of claim 2, wherein the contraction induction control unit comprises:
a controller configured to control the compression, applied by the compressive headgear;
a compression application engine configured to determine a target muscle contraction level;
one or more sensors operably coupled to the controller, configured to monitor pressure applied by the compressive headgear.

9. The apparatus of claim 8, wherein the contraction induction control unit further comprises a user interface configured to receive input from a user.

10. The apparatus of claim 8, wherein the compression application engine is configured to dynamically generate a target muscle contraction level based on a contraction level model.

11. The apparatus of claim 8, wherein the one or more sensors include a pressure sensor configured to detect a pressure applied to the head by the compression module.

12. The apparatus of claim 8, wherein the contraction induction control unit is configured to be autonomously operated based on measurements from the one or more sensors.
The apparatus of claim 2, wherein the controller is configured to selectively operate the compressive headgear to induce uterine contraction.

13. The apparatus of claim 2, wherein the controller is configured to selectively operate the compressive headgear to induce bowel movement.

14. A method of inducing contraction of muscles surrounding a target body cavity, comprising:
providing a compressive headgear configured to selectively apply compression to a plurality of predetermined points on a head of a patient, the compressive headgear comprising a contraction induction control unit coupled to the compressive headgear, the contraction induction control unit operable to control a level of the compression, applied by the compressive headgear;
selectively applying compression to the plurality of predetermined points on a head of a patient using the compressive headgear, wherein the plurality of predetermined points comprise points located:
on a first parietal surface,
on a second parietal surface opposing the first parietal surface, and
on an occipital surface; and
controlling a level of the compression, applied by the compressive headgear using the contraction induction control unit, such that contraction of muscles surrounding the target body cavity is induced, thereby inducing evacuation of the target body cavity.

15. The method of claim 14, wherein selectively applying compression comprises applying a force to the contraction induction control unit such that the contraction induction control unit transfers the force into a corresponding level of the compression.

16. The method of claim 15, wherein applying the force comprises pulling one or more handles.

17. The method of claim 15, wherein applying the force comprises squeezing one or more input modules.

18. The method of claim 14, wherein selectively applying compression comprises operating a control interface of the contraction induction control unit such that the contraction induction control unit controls activation of one or more actuators of the compressive headgear such that a corresponding level of the compression is applied.

19. The method of claim 14, wherein the target body cavity comprises bowels.

20. The method of claim 14, wherein the target body cavity comprises a uterus.
